(19) United States
(12) Patent Application Publication
(10) Pub. No.: US 2026/0333306 A1
(43) Pub. Date: Oct. 22, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 19/105,527

(22) PCT Filed: Jul. 24, 2023
(86) PCT No.: PCT/JP2023/026958

§ 371 Date: Feb. 21, 2025

(30) Foreign Application Priority Data
Aug. 25, 2022 (JP) 2022-134022

(51) Int. Cl. H04W 72/044; H04W 16/28; H04W 72/20

(52) U.S. Cl. CPC H04W 72/044; H04W 16/28; H04W 72/20

(57) ABSTRACT

A terminal according to an aspect of the present disclosure includes a control section that determines, in a case that configuration information related to a single frequency network (SFN) physical downlink control channel (PDCCH) is configured for a specific scheme and that configuration information related to an SFN physical downlink shared channel (PDSCH) is not configured, when a period from downlink control information scheduling a PDSCH to the PDSCH is shorter than a specific threshold, a Transmission Configuration Indication (TCI) state to be applied to the PDSCH on the basis of a TCI state indicated for a PDCCH configured in a symbol at least the same as a symbol of the PDSCH, and a receiving section that receives the PDSCH. An aspect of the present disclosure enables operations related to a TCI state/QCL assumption to be appropriately controlled.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement, and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G)”, “5G+ (plus)”, “6th generation mobile communication system (6G)”, “New Radio (NR)”, “3GPP Rel. 15 (or later versions)”, or the like) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), it is under study that a method of receiving a physical downlink control channel (PDCCH) and a physical downlink shared channel (PDSCH), for higher reliability/higher speed mobility, is configured for a control resource set (CORESET).

Meanwhile, in some cases, studies have not sufficiently been made on how a TCI state/QCL assumption is applied in a terminal (user terminal, User Equipment (UE)). For such cases, degradation in communication quality, throughput reduction, and the like may be caused.

In view of this, one object of the present disclosure is to provide a terminal, a radio communication method, and a base station that appropriately control operations related to a TCI state/QCL assumption.

### Solution to Problem

A terminal according to an aspect of the present disclosure includes a control section that determines, in a case that configuration information related to a single frequency network (SFN) physical downlink control channel (PDCCH) is configured for a specific scheme and that configuration information related to an SFN physical downlink shared channel (PDSCH) is not configured, when a period from downlink control information scheduling a PDSCH to the PDSCH is shorter than a specific threshold, a Transmission Configuration Indication (TCI) state to be applied to the PDSCH on the basis of a TCI state indicated for a PDCCH configured in a symbol at least the same as a symbol of the PDSCH, and a receiving section that receives the PDSCH.

### Advantageous Effects of Invention

An aspect of the present disclosure enables operations related to a TCI state/QCL assumption to be appropriately controlled.

### BRIEF DESCRIPTION OF DRAWINGS

FIGS. 1A and 1B are each a diagram to show an example of communication between a moving object and transmission points (for example, RRHs).

FIGS. 2A to 2C are diagrams to show examples of schemes 0 to 2 related to an SFN.

FIGS. 3A and 3B are each a diagram to show an example of scheme 1.

FIGS. 4A to 4C are each a diagram to show an example of an NW pre-compensation scheme.

FIG. 5 is a diagram to show an example of application of a TCI state.

FIG. 6 is a diagram to show an example of application of a TCI state according to an embodiment of the present disclosure.

FIG. 7 is a diagram to show an example of application of a TCI state according to an embodiment variation of the present disclosure.

FIG. 8 is a diagram to show an example of a schematic structure of a radio communication system according to one embodiment.

FIG. 9 is a diagram to show an example of a structure of a base station according to one embodiment.

FIG. 10 is a diagram to show an example of a structure of a user terminal according to one embodiment.

FIG. 11 is a diagram to show an example of a hardware structure of the base station and the user terminal according to one embodiment.

FIG. 12 is a diagram to show an example of a vehicle according to one embodiment.

### DESCRIPTION OF EMBODIMENTS

### TCI, Spatial Relation, QCL

For NR, control of reception processing (for example, at least one of reception, demapping, demodulation, or decoding) and transmission processing (for example, at least one of transmission, mapping, precoding, modulation, or coding) of at least one of a signal or a channel (which may be referred to as a signal/channel) in a UE, based on a transmission configuration indication state (TCI state), has been under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

### Default TCI State/Default Spatial Relation/Default PL-RS

In Rel. 16, a PDSCH may be scheduled by DCI having a TCI field. A TCI state for a PDSCH is indicated by a TCI field. A TCI field in DCI format 1-1 has three bits, and a TCI field in DCI format 1-2 has three bits at maximum.

In an RRC connected mode, if a first TCI-in-DCI information element (higher layer parameter tci-PresentInDCI) is set at “enabled” for a CORESET that a PDSCH is scheduled, a UE assumes that a TCI field is present in DCI format 1_1 of a PDCCH transmitted in the CORESET.

If a second TCI-in-DCI information element (higher layer parameter tci-PresentInDCI-1-2) for a CORESET that a PDSCH is scheduled is configured for a UE, the UE assumes that a TCI field having a DCI field size indicated by the second TCI-in-DCI information element is present in DCI format 1_2 of the PDSCH transmitted in the CORESET.

In Rel. 16, a PDSCH may be scheduled by DCI having no TCI field. The DCI format of the DCI may be DCI format 1_0 or DCI format 1_1/1_2 in a case where no TCI-in-DCI information element (higher layer parameter tci-PresentInDCI or tci-PresentInDCI-1-2) is configured (enabled). In a case where a PDSCH is scheduled by DCI having no TCI field and if the time offset between reception of DL DCI (DCI scheduling the PDSCH (scheduling DCI)) and the corresponding PDSCH (PDSCH scheduled by the DCI) is equal to or larger than a threshold (timeDurationForQCL), a UE assumes that the TCI state or QCL assumption for the PDSCH is the same as the TCI state or QCL assumption (default TCI state) of a CORESET (for example, scheduling DCI).

In the RRC connected mode, when the time offset between reception of DL DCI (DCI scheduling a PDSCH) and the corresponding PDSCH (PDSCH scheduled by the DCI) is smaller than the threshold (timeDurationForQCL) (application condition, first condition) in both a case where a TCI-in-DCI information element (higher layer parameter tci-PresentInDCI and tci-PresentInDCI-1-2) is set at “enabled” and a case where no TCI-in-DCI information element is configured, the TCI state of the PDSCH (default TCI state) may be the TCI state having the lowest CORESET ID in the latest slot in an active DL BWP in the CC (of a specific UL signal) if it is a case of non-cross carrier scheduling. Otherwise, the TCI state of the PDSCH (default TCI state) may be the TCI state having the lowest TCI state ID of the PDSCH in the active DL BWP in the CC scheduled.

In Rel. 15, individual MAC CEs, specifically, a MAC CE for activation/deactivation of a PUCCH spatial relation and a MAC CE for activation/deactivation of an SRS spatial relation, are required. A PUSCH spatial relation conforms to an SRS spatial relation.

In Rel. 16, at least one of a MAC CE for activation/deactivation of a PUCCH spatial relation or a MAC CE for activation/deactivation of an SRS spatial relation need not be used.

If neither spatial relation nor PL-RS for a PUCCH is configured in FR2 (application condition, second condition), default assumption of a spatial relation and default assumption of a PL-RS (default spatial relation and default PL-RS) are applied to the PUCCH. If neither spatial relation nor PL-RS for an SRS (SRS resource for an SRS or SRS resource corresponding to an SRI in DCI format 0_1 scheduling a PUSCH) is configured in FR2 (application condition, second condition), default assumption of a spatial relation and default assumption of a PL-RS (default spatial relation and default PL-RS) are applied to the PUSCH scheduled by DCI format 0_1 and the SRS.

If a CORESET is configured in the active DL BWP on the CC (application condition), the default spatial relation and the default PL-RS may correspond to the TCI state or QCL assumption of a CORESET having the lowest CORESET ID in the active DL BWP. If no CORESET is configured in the active DL BWP on the CC, the default spatial relation and the default PL-RS may correspond to an active TCI state having the lowest ID of a PDSCH in the active DL BWP.

In Rel. 15, the spatial relation of a PUSCH scheduled by DCI format 0_0 conforms to the spatial relation of a PUCCH resource having the lowest PUCCH resource ID, out of the active spatial relations of a PUCCH on the same CC. A network needs to update PUCCH spatial relations on all the SCells even when no PUCCH is transmitted on any SCell.

In Rel. 16, no PUCCH configuration is needed for a PUSCH scheduled by DCI format 0_0. When there is no active PUCCH spatial relation or there is no PUCCH resource on an active UL BWP in the CC for a PUSCH scheduled by DCI format 0_0 (application condition, second condition), a default spatial relation and a default PL-RS are applied to the PUSCH.

The application condition for a default spatial relation/default PL-RS for SRS may include that an enable default beam pathloss for SRS information element (higher layer parameter enableDefaultBeamPlForSRS) is set at enabled. The application condition for a default spatial relation/default PL-RS for PUCCH may include that an enable default beam pathloss for PUCCH information element (higher layer parameter enableDefaultBeamPlForPUCCH) is set at enabled. The application condition for a default spatial relation/default PL-RS for PUSCH scheduled by DCI format 0_0 may include that an enable default beam pathloss for PUSCH scheduled by DCI format 0_0 information element (higher layer parameter enableDefaultBeamPlForPUSCH0_0) is set at enabled.

In Rel. 16, for a UE, when an RRC parameter (parameter of enabling a default beam PL for PUCCH (enableDefaultBeamPL-ForPUCCH), a parameter of enabling a default beam PL for PUSCH (enableDefaultBeamPL-ForPUSCH0_0), or a parameter of enabling a default beam PL for SRS (enableDefaultBeamPL-ForSRS)) is configured and no spatial relation or PL-RS is configured, the UE applies a default spatial relation/PL-RS.

The threshold may be referred to as a time duration for QCL, “timeDurationForQCL”, “Threshold”, “Threshold for offset between a DCI indicating a TCI state and a PDSCH scheduled by the DCI”, “Threshold-Sched-Offset”, “beamSwitchTiming”, a schedule offset threshold, a scheduling offset threshold, or the like. The threshold may be reported by a UE as a UE capability (per subcarrier spacing). These names may be interchangeably interpreted.

In a case where the offset between reception of DL DCI and a corresponding PDSCH is smaller than a threshold timeDurationForQCL, where at least one TCI state configured for a serving cell of the scheduled PDSCH includes “QCL type D”, where a UE is configured with an enable two-default TCI information element (enableTwoDefaultTCIStates-r16), and where at least one TCI codepoint (codepoint of a TCI field in the DL DCI) indicates two TCI states, the UE assumes that a DMRS port of the PDSCH or PDSCH transmission occasion in the serving cell is QCLed (quasi co-located) with an RS related to a QCL parameter associated with two TCI states corresponding to the lowest codepoint out of TCI codepoints including two different TCI states (two-default QCL assumption determination rule). The enable two-default TCI information element indicates that an Rel-16 operation for two default TCI states for PDSCH when at least one TCI codepoint is mapped to two TCI states is enabled.

As a default TCI state of a PDSCH in Rel. 15/16, specifications of a default TCI state for single TRP, a default TCI state for multi-TRP based on multi-DCI, and a default TCI state for multi-TRP based on single DCI have been drafted.

As a default TCI state of an aperiodic CSI-RS (A-CSI-RS) in Rel. 15/16, specifications of a default TCI state for single TRP, a default TCI state for multi-TRP based on multi-DCI, and a default TCI state for multi-TRP based on single DCI have been drafted.

In Rel. 15/16, specifications of a default spatial relation and a default PL-RS for each of a PUSCH/PUCCH/SRS have been drafted.

### Multi-TRP

For NR, it is under study that one or a plurality of transmission/reception points (TRPs) (multi-TRP (multi TRP (MTRP))) perform DL transmission to a UE by using one or a plurality of panels (multi-panel). It is also under study that the UE performs UL transmission to the one or plurality of TRPs by using one or a plurality of panels.

Note that the plurality of TRPs may correspond to the same cell identifier (ID) or may correspond to different cell IDs. The cell ID may be a physical cell ID or a virtual cell ID.

The multi-TRP (for example, TRPs #1 and #2) may be connected via an ideal/non-ideal backhaul to exchange information, data, or the like. Each TRP of the multi-TRP may transmit a different codeword (Code Word (CW)) and a different layer. As one mode of multi-TRP transmission, non-coherent joint transmission (NCJT) may be used.

In NCJT, for example, TRP #1 performs modulation mapping on a first codeword, performs layer mapping, and transmits a first PDSCH in layers of a first number (for example, two layers) by using first precoding. TRP #2 performs modulation mapping on a second codeword, performs layer mapping, and transmits a second PDSCH in layers of a second number (for example, two layers) by using second precoding.

Note that a plurality of PDSCHs (multi-PDSCH) transmitted by NCJT may be defined to partially or entirely overlap in terms of at least one of the time or frequency domain. In other words, a first PDSCH from a first TRP and a second PDSCH from a second TRP may overlap in terms of at least one of the time or frequency resource.

The first PDSCH and second PDSCH may be assumed not to be in a quasi-co-location (QCL) relationship (not to be quasi-co-located). Reception of multi-PDSCH may be interpreted as simultaneous reception of PDSCHs of a QCL type other than a certain QCL type (for example, QCL type D).

A plurality of PDSCHs (which may be referred to as multi-PDSCH (multiple PDSCHs)) from multi-TRP may be scheduled by using one piece of DCI (single DCI, single PDCCH) (single master mode, multi-TRP based on single DCI (single-DCI based multi-TRP)). The plurality of PDSCHs from the multi-TRP may be separately scheduled by using a plurality of pieces of DCI (multi-DCI, multi-PDCCH (multiple PDCCHs)) (multi-master mode, multi-TRP based on multi-DCI (multi-DCI based multi-TRP)).

For Ultra-Reliable and Low Latency Communications (URLLC) for multi-TRP, it is under study to support PDSCH (transport block (TB) or codeword (CW)) repetition over multi-TRP. It is under study to support a scheme of repetition over multi-TRP in the frequency domain, layer (space) domain, or time domain (URLLC scheme, reliability enhancement scheme, for example, schemes 1a, 2a, 2b, 3, and 4). In scheme 1a, multi-PDSCH from multi-TRP is space division multiplexed (SDMed). In schemes 2a and 2b, PDSCHs from multi-TRP are frequency division multiplexed (FDMed). In scheme 2a, the same redundancy version (RV) is used for the multi-TRP. In scheme 2b, the same or different RVs may be used for the multi-TRP. In schemes 3 and 4, multi-PDSCH from multi-TRP is time division multiplexed (TDMed). In scheme 3, multi-PDSCH from multi-TRP is transmitted in one slot. In scheme 4, multi-PDSCH from multi-TRP is transmitted in different slots.

Such a multi-TRP scenario enables more flexible transmission control using a channel with high quality.

In order to support intra-cell (with the same cell ID) and inter-cell (with different cell IDs) multi-TRP transmission based on a plurality of PDCCHs, in RRC configuration information for linkage of a plurality of pairs of a PDCCH and PDSCH including a plurality of TRPs, one control resource set (CORESET) in PDCCH configuration information (PDCCH-Config) may correspond to one TRP.

When at least one of condition 1 or 2 below is met, a UE may determine that it is multi-TRP based on multi-DCI. In this case, a TRP may be interpreted as a CORESET pool index.

### Condition 1

One CORESET pool index is configured.

### Condition 2

Two different values (for example, 0 and 1) of CORESET pool indices are configured.

When the following condition is met, the UE may determine that it is multi-TRP based on single DCI. In this case, two TRPs may be interpreted as two TCI states indicated by a MAC CE/DCI.

### Condition

In order to indicate one or two TCI states for one codepoint of a TCI field in DCI, an “enhanced TCI states activation/deactivation for UE-specific PDSCH MAC CE” is used.

DCI for common beam indication may be a UE-specific DCI format (for example, DL DCI format (for example, 1_1, 1_2), UL DCI format (for example, 0_1, 0_2)) or may be a UE-group common DCI format.

### Multi-TRP PDCCH

For reliability of a multi-TRP PDCCH based on non-single frequency network (SFN), studies 1 to 3 below are under study.
{Study 1} Coding/rate matching is based on one repetition, and the same coding bits are repeated in another repetition.
{Study 2} Each repetition has the same number of control channel elements (CCEs) and the same coding bits and corresponds to the same DCI payload.
{Study 3} Two or more PDCCH candidates are explicitly linked to each other. A UE finds the link before decoding.

Choices 1-2, 1-3, 2, and 3 below for PDCCH repetition are under study.

### Choice 1-2

Two sets of PDCCH candidates (in a given search space (SS) set) are associated with two respective TCI states of a CORESET. Here, the same CORESET, the same SS set, and PDCCH repetitions in different monitoring occasions are used.

### Choice 1-3

Two sets of PDCCH candidates are associated with two respective SS sets. Both of the SS sets are associated with a CORESET, and each SS set is associated with only one TCI state of the CORESET. Here, the same CORESET and two SS sets are used.

### Choice 2

One SS set is associated with two different CORESETs.

### Choice 3

Two SS sets are associated with two respective CORESETs.

As described above, it is under study that two PDCCH candidates in two SS sets for PDCCH repetitions are supported and the two SS sets are explicitly linked.

### (SFN PDCCH)

For a PDCCH/CORESET defined in Rel. 15, one TCI state without any CORESET pool index (CORESETPoolIndex) (which may be referred to as TRP information (TRP Info)) is configured for one CORESET.

For enhancement of a PDCCH/CORESET defined in Rel. 16, a CORESET pool index is configured for each CORESET in multi-TRP based on multi-DCI.

For Rel. 17 or later versions, enhancements 1 and 2 below related to a PDCCH/CORESET are under study.

In a case where a plurality of antennas (small antennas, transmission/reception points) having the same cell ID form a single frequency network (SFN), two TCI states may be configured/activated at maximum for one CORESET by higher layer signaling (RRC signaling/MAC CE) (enhancement 1). An SFN contributes to improvement of at least one of management or reliability of an HST (high speed train).

In PDCCH repetition transmission (which may be simply referred to as “repetition”), two PDCCH candidates in two search space sets are linked, and each search space set is associated with a corresponding CORESET (enhancement 2). The two search space sets may be associated with the same or different CORESETs. For one CORESET, one TCI state (one at maximum) may be configured/activated by higher layer signaling (RRC signaling/MAC CE).

If two search space sets are associated with different CORESETs having different TCI states, this may mean multi-TRP repetition transmission. If two search space sets are associated with the same CORESET (CORESETs having the same TCI state), this may mean single-TRP repetition transmission.

### HST

In LTE, arrangement of an HST (high speed train) in a tunnel is difficult. A large antenna performs transmission to the outside/inside of a tunnel. For example, such a large antenna has transmission power of approximately 1 to 5 W. For handover, it is important to perform transmission to the outside of a tunnel before a UE enters the tunnel. For example, a small antenna has transmission power of approximately 250 mW. A plurality of small antennas (transmission/reception points) having the same cell ID and having a distance of 300 m form a single frequency network (SFN). All the small antennas in such an SFN transmit identical signals on the same PRB at the same time. It is assumed that a terminal performs transmission/reception to and from one base station. In actual, a plurality of transmission/reception points transmit identical DL signals. At high speed movement, transmission/reception points in several km units form one cell. Handover is performed at the time of moving over cells. This enables handover to be performed less frequently.

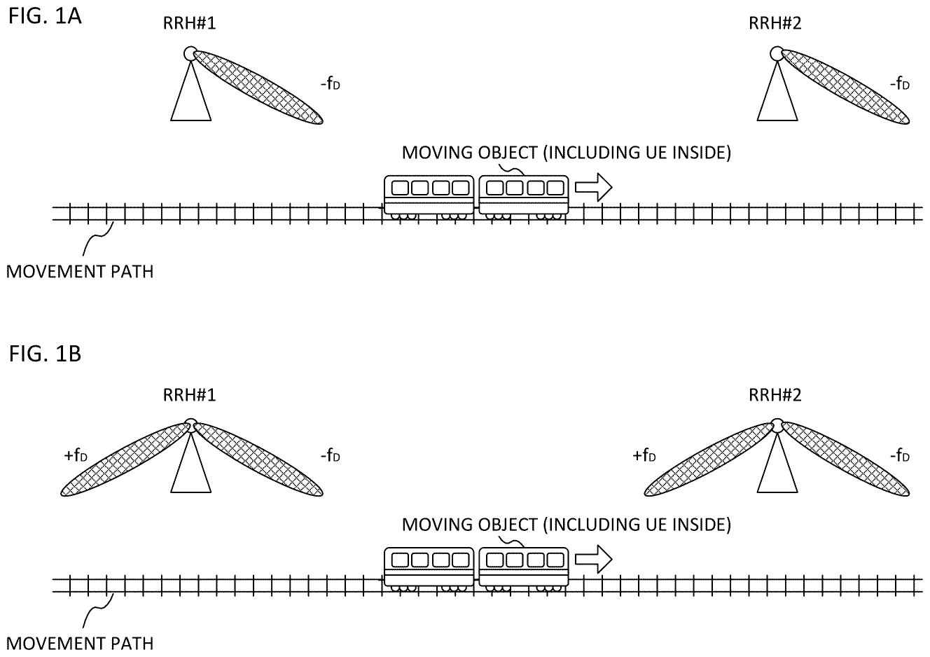

In NR, it is assumed that, in order to perform communication with a terminal (also referred to as a UE below) included in a moving object such as a train moving at high speed (HST (high speed train)), beams transmitted from transmission points (for example, RRHs) are used. In an existing system (for example, Rel. 15), transmitting uni-directional beams from RRHs to perform communication with a moving object is supported (see FIG. 1A).

FIG. 1A shows a case where RRHs are installed along a movement path (movement direction, travel direction, or traveling path) of a moving object and a beam is formed in the travel direction of the moving object from each RRH. An RRH forming a uni-directional beam may be referred to as a uni-directional RRH. In the example shown in FIG. 1A, the moving object receives minus Doppler shift (−f_{D}) from each RRH.

Note that, although a case where each beam is formed in the travel direction of the moving object is shown here, this is not restrictive. The beam may be formed in a direction opposite to the travel direction or may be formed in any direction irrespective of the travel direction of the moving object.

In Rel. 16 or later versions, it is also assumed that a plurality of (for example, two or more) beams are transmitted from each RRH. For example, it is assumed that beams are formed in both a travel direction of a moving object and a direction opposite to the travel direction (see FIG. 1B).

FIG. 1B shows a case where RRHs are installed along a movement path of a moving object and beams are formed in both a travel direction of the moving object and a direction opposite to the travel direction from each RRH. An RRH forming multi-directional (for example, bi-directional) beams may be referred to as a bi-directional RRH.

In an HST, a UE performs communication similarly to a case of a single TRP. In base station implementation, transmission is possible to be performed from a plurality of TRPs (same cell ID).

In the example in FIG. 1B, in a case where two RRHs (here, RRH #1 and RRH #2) use an SFN, signals are switched from a signal having received minus Doppler shift to a signal having received plus Doppler shift with higher power, when the moving object is midway between the two RRHs. In this case, the maximum change width of Doppler shift requiring correction is a change from −f_{D} to +f_{D}, which is twice as much as that of a case with uni-directional RRHs.

Here, as a scheme for HST, scheme 0 to scheme 2 below (HST scheme 0 to HST scheme 2) are compared.

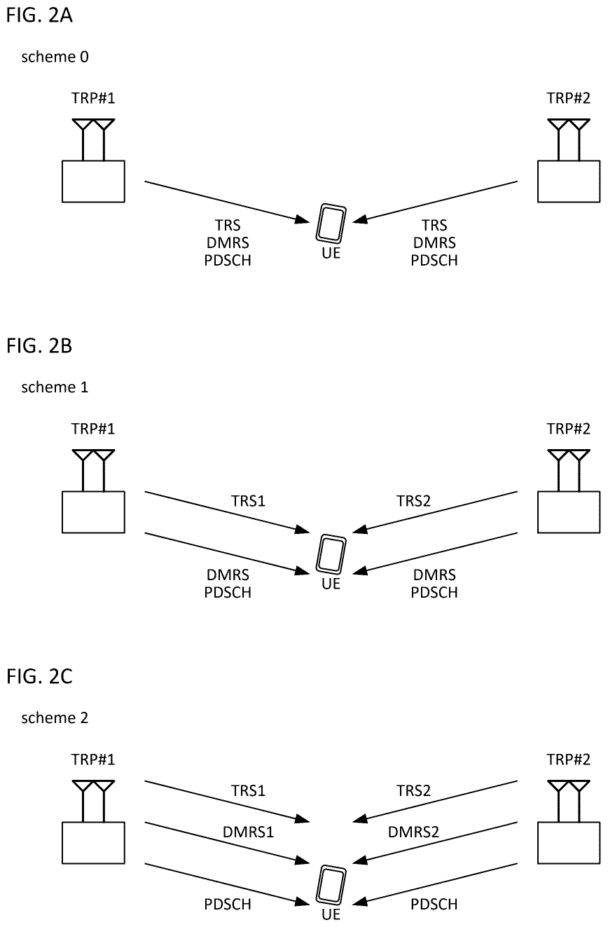

In scheme 0 in FIG. 2A, a tracking reference signal (TRS), a DMRS, and a PDSCH are transmitted commonly from two TRPs (RRHs) (by using the same time and the same frequency resources) (normal SFN, transparent SFN, HST-SFN).

In scheme 0, since a UE receives DL channels/signals the equivalent of that for a single TRP, the number of TCI states of the PDSCH is one.

Note that, in Rel. 16, an RRC parameter to distinguish transmission using a single TRP and transmission using an SFN is defined. When a UE reports corresponding UE capability information, the UE may distinguish reception of a DL channel/signal of a single TRP and reception of PDSCHs assuming an SFN, based on the RRC parameter. Meanwhile, the UE may perform transmission/reception using an SFN on the assumption of a single TRP.

In scheme 1 in FIG. 2B, TRSs are transmitted in a TRP-specific manner (by using different time/frequency resources depending on respective TRPs). In this example, TRS1 is transmitted from TRP #1 and TRS2 is transmitted from TRP #2.

In scheme 1, since a UE receives DL channels/signals from the respective TRPs by using the TRSs from the respective TRPs, the number of TCI states of the PDSCH is two.

Note that, in the present disclosure, scheme 1 of SFN (SFN scheme 1) may be referred to as SFN scheme A.

In scheme 2 in FIG. 2C, TRSs and DMRSs are transmitted in a TRP-specific manner. In this example, TRS1 and DMRS1 are transmitted from TRP #1 and TRS2 and DMRS2 are transmitted from TRP #2. Schemes 1 and 2 are each possible to suppress an abrupt change in Doppler shift and appropriately estimate/compensate Doppler shift, as compared with scheme 0. The number of DMRSs in scheme 2 is larger than the number of DMRSs in scheme 1, and thus the maximum throughput in scheme 2 is lower than that in scheme 1.

In scheme 0, the UE switches a single TRP and an SFN, based on higher layer signaling (RRC information element/MAC CE).

The UE may switch scheme 1/scheme 2/NW pre-compensation scheme, based on higher layer signaling (RRC information element/MAC CE).

In scheme 1, two respective TRS resources are configured for the travel direction of the HST and the opposite direction to the travel direction.

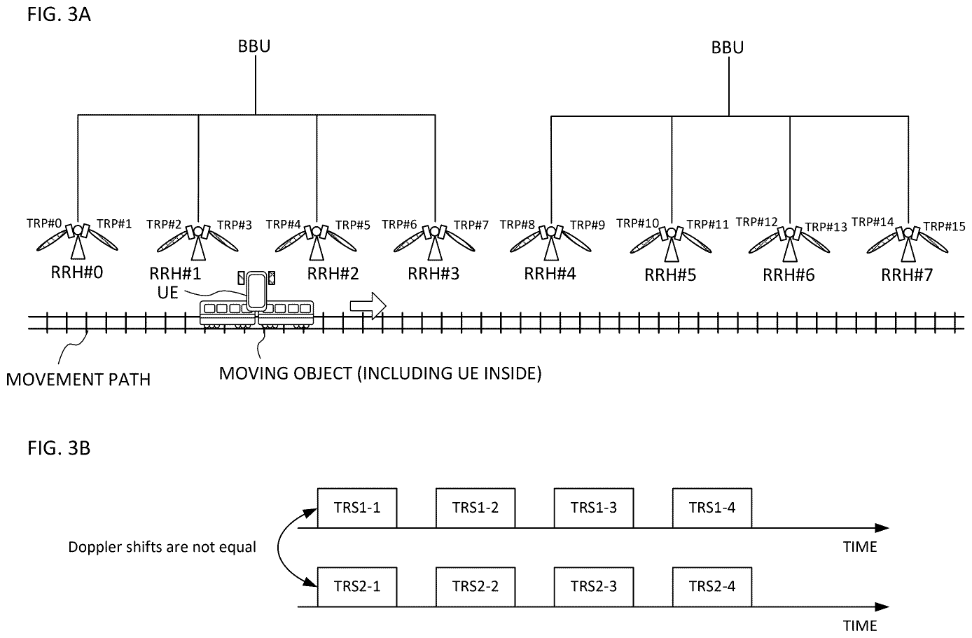

In an example in FIG. 3A, TRPs that transmit DL signals in the opposite direction of the HST (TRPs #0, #2, . . . ) each transmit a first TRS (a TRS arriving from the front of the HST) in the same time and frequency resources (SFN). TRPs that transmit DL signals in the travel direction of the HST (TRPs #1, #3, . . . ) each transmit a second TRS (a TRS arriving from the rear of the HST) in the same time and frequency resources (SFN). The first TRS and second TRS may be transmitted/received by using different frequency resources.

In an example in FIG. 3B, TRSs 1-1 to 1-4 are transmitted as the first TRSs and TRSs 2-1 to 2-4 are transmitted as the second TRSs.

In consideration of beam management, the first TRSs are transmitted by using 64 beams and 64 time resources and the second TRSs are transmitted by using 64 beams and 64 time resources. The beams of the first TRSs and the beams of the second TRSs are considered to be equal (equal in QCL type D RS). Multiplexing the first TRSs and second TRSs in the same time resources and different frequency resources enables resource utilization efficiency to be enhanced.

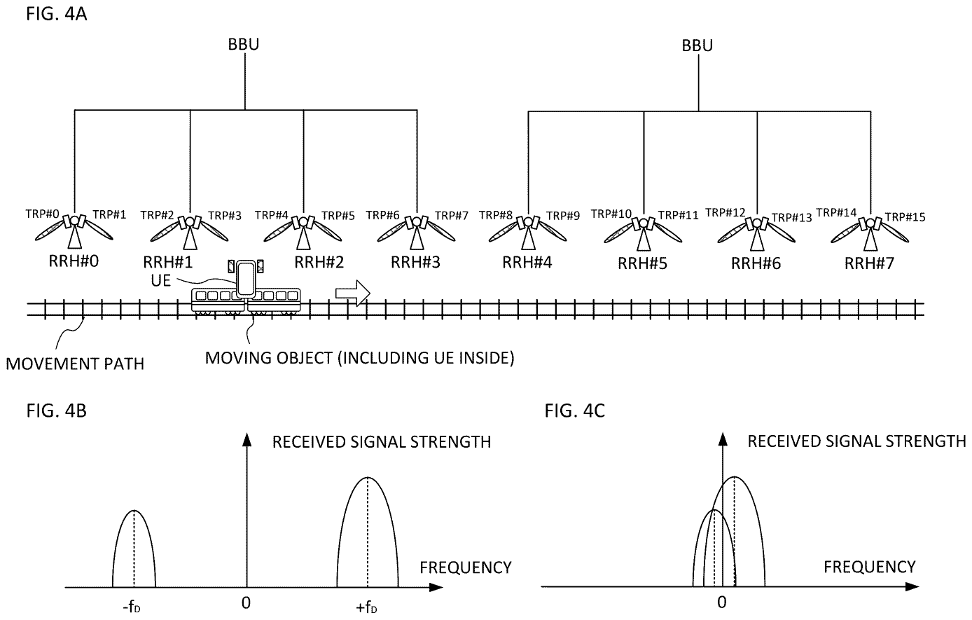

In an example in FIG. 4A, RRHs #0 to #7 are installed along a movement path of an HST. RRHs #0 to #3 are connected to baseband unit (BBU) #0 and RRHs #4 to #7 are connected to BBU #1. Each RRH is a bi-directional RRH and forms beams in both the travel direction of the movement path and the opposite direction to the travel direction by using respective transmission/reception points (TRPs).

In a received signal in an example in FIG. 4B (single TRP (SFN)/scheme 1), when a UE receives a signal/channel (a beam in a travel direction of an HST, a beam from the rear of the UE) transmitted from TRP #(2n−1) (n is an integer equal to or larger than 0), minus Doppler shift (−f_{D} in this example) occurs. When the UE receives a signal/channel (a beam in the opposite direction to the travel direction of the HST, a beam from the front of the UE) transmitted from TRP #2n (n is an integer equal to or larger than 0), plus Doppler shift (+f_{D} in this example) occurs.

For Rel. 17 or later versions, it is under study to perform Doppler shift correction (which may be referred to as Doppler correction (Doppler Compensation), preliminary Doppler correction (Pre-Doppler Compensation), or network (NW) preliminary correction scheme (NW pre-compensation scheme, HST NW pre-compensation scheme, TRP based pre-compensation scheme)) in transmission of a downlink (DL) signal/channel to a UE in an HST from a TRP. In transmission of a DL signal/channel to the UE, the TRP performs Doppler correction in advance, enabling an influence of Doppler shift at the time of reception of the DL signal/channel in the UE to be reduced.

In the present disclosure, an NW pre-compensation scheme may be a combination of scheme 1 and Doppler shift preliminary correction by a base station. In the present disclosure, an NW pre-compensation and a TRP based pre-compensation scheme may each be referred to as SFN scheme B.

In the NW pre-compensation scheme, a TRP that forms a beam in a travel direction of a movement path and a TRP that forms a beam in the opposite direction to the travel direction of the movement path each perform Doppler correction and then transmit a DL signal/channel to a UE in an HST. In this example, TRP #(2n−1) performs plus Doppler correction and TRP #2n performs minus Doppler correction to thereby reduce an influence of Doppler shift at the time of reception of signals/channels in the UE (FIG. 4C).

Note that, in the situation in FIG. 4C, since the UE receives DL channels/signals from the respective TRPs by using TRSs from the respective TRPs, the number of TCI states of the PDSCHs may be two.

Further, for Rel. 17 or later versions, it is under study to dynamically switch a single TRP and an SFN by using a TCI field (TCI state field). For example, by using an RRC information element/MAC CE (for example, Enhanced TCI States Activation/Deactivation for UE-specific PDSCH MAC CE)/DCI (TCI field), one or two TCI states are configured/indicated with each TCI codepoint (codepoint of the TCI field, DCI codepoint). When a UE is configured/indicated with one TCI state, the UE may determine to receive a PDSCH of a single TRP. When the UE is configured/indicated with two TCI states, the UE may determine to receive PDSCHs of an SFN using multi-TRP.

### Analysis

For future radio communication systems, a case is conceivable where an SFN-CORESET (a CORESET with two active TCI states, sfnSchemePdcch) is configured and no SFN (SFN scheme, sfnSchemePdsch) is configured for a PDSCH.

In such a case, when a scheduling offset regarding scheduling DCI is smaller than a threshold (for example, “timeDurationForQCL”), QCL assumption for the PDSCH may correspond to a CORESET having the lowest CORESET ID in the latest slot. For the CORESET, when two active TCI states are indicated, a first TCI state out of the two may be applied to the PDSCH.

Regarding default QCL other than the SFN-CORESET, when a PDCCH and a PDSCH are configured in the same symbol, a UE may prioritize reception of the PDCCH. Note that, at that time, the UE may or may not receive the PDSCH by using the QCL assumption of the PDCCH.

Meanwhile, regarding the SFN-CORESET, when a PDCCH (a DMRS for the PDCCH) and a PDSCH (a DMRS for the PDSCH) different in QCL type D are configured in at least one same symbol, it is conceivable that a UE prioritizes reception of the PDCCH.

In this case, however, the PDSCH may not be appropriately received in a specific case.

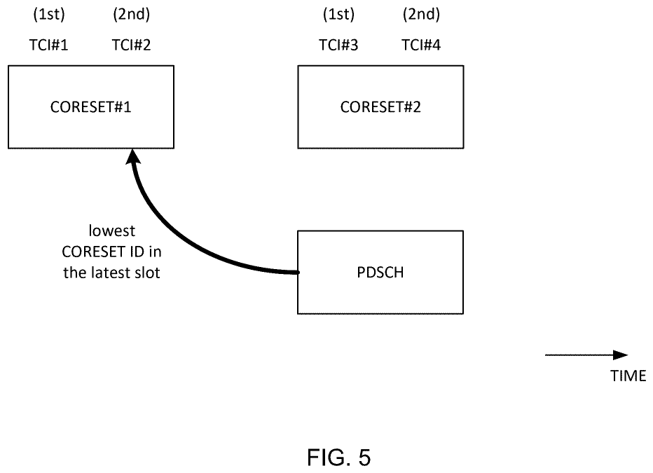

Specifically, as shown in FIG. 5, a case is considered where two active TCI states (TCI #1 and TCI #2) are indicated for CORESET #1 (PDCCH) configured in the latest slot before a PDSCH and two active TCI states (TCI #3 and TCI #4) are indicated for CORESET #2 (PDCCH) configured in a symbol at least the same as that of the PDSCH.

In such a case, in accordance with the above-described default QCL determination method, out of the TCI states having the lowest CORESET ID in the latest slot, TCI #1 being the first TCI state is applied to the PDSCH.

In contrast, if CORESET #2 (PDCCH) in a symbol the same as that of the PDSCH is prioritized, it is conceivable that the TCI states of CORESET #2 are applied to the PDSCH.

A UE is, however, not able to receive the PDSCH by assuming/using the two TCI states (TCI #3 and TCI #4) when the PDSCH is a single-TRP PDSCH.

Unless studies are sufficiently made on such a case where the PDSCH is not able to be appropriately received, a TCI state/QCL assumption may not be appropriately decided/determined/applied, causing degradation in communication quality, throughput reduction, and the like.

In view of this, the inventors of the present invention came up with the idea of a method of appropriately controlling operations related to a TCI state/QCL assumption.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, or C”.

In the present disclosure, notify, activate, deactivate, indicate (or specify), select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

The panel may be related to at least one of a group index of an SSB/CSI-RS group, a group index of group-based beam report, and a group index of an SSB/CSI-RS group for group-based beam report.

A panel Identifier (ID) and a panel may be interchangeably interpreted. In other words, a TRP ID and a TRP, a CORESET group ID and a CORESET group, and the like may be interchangeably interpreted.

In the present disclosure, a TRP, a transmission point, a panel, a DMRS port group, a CORESET pool, and one of two TCI states associated with one codepoint of a TCI field may be interchangeably interpreted.

In the present disclosure, a single TRP, a single-TRP system, single-TRP transmission, and a single PDSCH may be interchangeably interpreted. In the present disclosure, multi-TRP, a multi-TRP system, multi-TRP transmission, and multi-PDSCH may be interchangeably interpreted. In the present disclosure, single DCI, a single PDCCH, multi-TRP based on single DCI, and two TCI states in at least one TCI codepoint being activated may be interchangeably interpreted.

In the present disclosure, a single TRP, a channel using a single TRP, a channel using one TCI state/spatial relation, multi-TRP being not enabled by RRC/DCI, a plurality of TCI states/spatial relations being not enabled by RRC/DCI, and one CORESET pool index (CORESETPoolIndex) value being not configured for any CORESET and any codepoint of a TCI field being not mapped to two TCI states may be interchangeably interpreted.

In the present disclosure, multi-TRP, a channel using multi-TRP, a channel using a plurality of TCI states/spatial relations, multi-TRP being enabled by RRC/DCI, a plurality of TCI states/spatial relations being enabled by RRC/DCI, and at least one of multi-TRP based on single DCI and multi-TRP based on multi-DCI may be interchangeably interpreted. In the present disclosure, multi-TRP based on multi-DCI and one CORESET pool index (CORESETPoolIndex) value being configured for a CORESET may be interchangeably interpreted. In the present disclosure, multi-TRP based on single DCI and at least one codepoint in a TCI field being mapped to two TCI states may be interchangeably interpreted.

In the present disclosure, TRP #1 (first TRP) may correspond to CORESET pool index=0 or may correspond to the 1st TCI state out of two TCI states corresponding to one codepoint of a TCI field. TRP #2 (second TRP) may correspond to CORESET pool index=1 or may correspond to the 2nd TCI state out of two TCI states corresponding to one codepoint of a TCI field.

In the present disclosure, single DCI (sDCI), a single PDCCH, a multi-TRP system based on single DCI, sDCI-based MTRP, and two TCI states in at least one TCI codepoint being activated may be interchangeably interpreted.

In the present disclosure, multi-DCI (mDCI), multi-PDCCH, a multi-TRP system based on multi-DCI, mDCI-based MTRP, and two CORESET pool indices or CORESET pool index=1 (or a value equal to one or greater) being configured may be interchangeably interpreted.

QCL (type) in the present disclosure may be interpreted as any QCL type (for example, QCL type A/B/C/D), and vice versa.

In the present disclosure, “TCI state A is of the same QCL type A/D as that of TCI state B”, “TCI state A is the same as TCI state B”, “TCI state A is of QCL type A/D with TCI state B”, “TCI state A is in a relationship of QCL type A/D with TCI state B”, and the like may be interchangeably interpreted.

In the present disclosure, a codepoint of a DCI field ‘Transmission Configuration Indication’, a TCI codepoint, a DCI codepoint, and a codepoint of a TCI field may be interchangeably interpreted.

In the present disclosure, DCI including no TCI field may mean DCI format 1_0. In the present disclosure, DCI including no TCI field may mean DCI format 1_1/1_2 in a case that a specific higher layer parameter (for example, a parameter indicating presence of a TCI (for example, tci-PresentInDCI)) is configured/enabled.

In the present disclosure, a single TRP and an SFN may be interchangeably interpreted. In the present disclosure, an HST, an HST scheme, a scheme for high speed mobility, scheme 1, scheme 2, an NW pre-compensation scheme, HST scheme 1, HST scheme 2, and an HST NW pre-compensation scheme may be interchangeably interpreted.

In the present disclosure, a PDSCH/PDCCH using a single TRP may be interpreted as a PDSCH/PDCCH based on a single TRP, a single-TRP PDSCH/PDCCH, or a non-SFN PDSCH/PDCCH, and vice versa. In the present disclosure, a PDSCH/PDCCH using an SFN may be interpreted as a PDSCH/PDCCH using an SFN in multi-TRP, a PDSCH/PDCCH based on an SFN, or an SFN PDSCH/PDCCH, and vice versa.

In the present disclosure, reception of a DL signal (PDSCH/PDCCH) by using an SFN may mean reception, from a plurality of transmission/reception points, that uses the same time/frequency resource and/or that is of the same data (PDSCH)/control information (PDCCH). Reception of a DL signal by using an SFN may mean reception, using a plurality of TCI states/spatial domain filters/beams/QCLs, that uses the same time/frequency resource and/or that is of the same data/control information.

In the present disclosure, an HST-SFN scheme, an SFN scheme in Rel. 17 or later versions, a new SFN scheme, a new HST-SFN scheme, an HST-SFN scenario in Rel. 17 or later versions, an HST-SFN scheme for an HST-SFN scenario, an SFN scheme for an HST-SFN scenario, scheme 1, a Doppler advance compensation scheme, and at least one of scheme 1 (HST scheme 1) or Doppler advance compensation scheme may be interchangeably interpreted. In the present disclosure, a Doppler advance compensation scheme, a base station advance compensation scheme, a TRP advance compensation scheme, a pre-Doppler compensation scheme, a Doppler pre-compensation scheme, an NW pre-compensation scheme, an HST NW pre-compensation scheme, a TRP pre-compensation scheme, and a TRP-based pre-compensation scheme may be interchangeably interpreted. In the present disclosure, an advance compensation scheme, a reduction scheme, an improvement scheme, and a correction scheme may be interchangeably interpreted.

In the present disclosure, a received DL channel/signal, a DL channel/signal, DL reception, a received signal, a received channel, and the like may be interchangeably interpreted. In the present disclosure, a UL channel/signal, transmission of a UL channel/signal, and UL transmission may be interchangeably interpreted. In the present disclosure, a signal and a channel may be interchangeably interpreted. In the present disclosure, buffering and buffer may be interchangeably interpreted.

In the present disclosure, a first TCI state may mean at least one of a 1st TCI state or a TCI state having a small (or large) TCI state ID. A second TCI state may mean at least one of a 2nd TCI state or a TCI state having a large (or small) TCI state ID. In the present disclosure, a first TCI state and a second TCI state may be interchangeably interpreted.

In embodiments of the present disclosure, although a case of two (default) TCI states is mainly described as an example, the number of TCI states is not limited to two, and the embodiments are applicable to a case of more than two (default) TCI states as appropriate.

In the present disclosure, a CORESET and a PDCCH may be interchangeably interpreted.

### Radio Communication Method

For a UE, an SFN-CORESET (a CORESET with two active TCI states) may be configured.

For a UE, an SFN for PDSCH (an SFN scheme, sfnSchemePdsch) need not be configured.

In the present disclosure, a case that an SFN-CORESET is configured, a case that an SFN for PDCCH is configured, a case that an SFN-for-PDCCH configuration parameter (for example, sfnSchemePdcch) is configured with a specific value/condition (for example, scheme A, sfnSchemeA), and a case that a CORESET with two active TCI states is configured may be interchangeably interpreted.

In the present disclosure, a case that no SFN for PDSCH is configured and a case that no SFN-for-PDSCH configuration parameter (for example, sfnSchemePdsch) is configured may be interchangeably interpreted. When a UE is not configured with any SFN-for-PDSCH configuration parameter (for example, sfnSchemePdsch), the UE may determine that a PDSCH using a single TRP is to be used. When a UE is not configured with any SFN-for-PDSCH configuration parameter (for example, sfnSchemePdsch), the UE may determine that a PDSCH using a single TRP is to be configured.

When a scheduling offset regarding scheduling DCI is smaller than a threshold (for example, “timeDurationForQCL”), a UE may apply, to a PDSCH corresponding to the scheduling DCI, a specific TCI state/QCL assumption (application 1).

The specific TCI state/QCL assumption may be, for example, a TCI state/QCL assumption indicated for a CORESET having the lowest CORESET ID in the latest slot. For the CORESET, when two active TCI states are indicated, a UE may determine that a first TCI state (or second TCI state) out of the two is to be applied to the PDSCH.

### Embodiments

Regarding an SFN-CORESET, when a PDCCH/CORESET and a PDSCH are configured in at least one same symbol, a UE may prioritize reception of the PDCCH/CORESET (operation 1).

In the present disclosure, prioritizing reception of a PDCCH/CORESET, receiving no PDSCH, and applying a TCI state of a PDCCH/CORESET in a symbol the same as that of a PDSCH to reception of the PDSCH may be interchangeably interpreted.

QCL type D of the PDCCH/CORESET/a DMRS for the PDCCH may be different from QCL type D of the PDSCH/a DMRS for the PDSCH.

For a PDCCH/CORESET in a symbol the same as that of a PDSCH, application of operation 1 described above may be limited to a case where one TCI state is activated. For a PDCCH/CORESET in a symbol the same as that of a PDSCH, application of operation 1 described above may be limited to a case where one active TCI state is indicated.

For example, for a PDCCH/CORESET in a symbol the same as that of a PDSCH, a UE may apply operation 1 described above (only) when one TCI state is activated.

For a PDCCH/CORESET in a symbol the same as that of a PDSCH, an SFN scheme need not be configured. For a PDCCH/CORESET in a symbol the same as that of a PDSCH, an SFN scheme may be configured and the number of active TCI states indicated may be one.

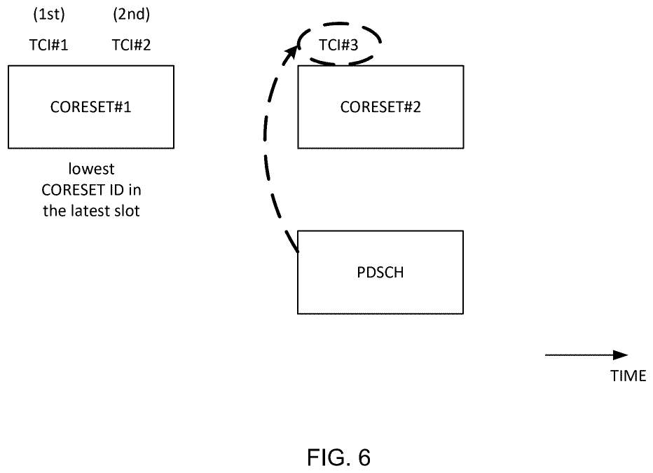

FIG. 6 is a diagram to show an example of application of a TCI state according to an embodiment of the present disclosure. In the example shown in FIG. 6, CORESET #1 in the latest slot before reception of a PDSCH is configured and CORESET #2 is configured in at least one symbol the same as that of the PDSCH. For CORESET #1, TCI #1 and TCI #2 are indicated as active TCI states. For CORESET #2, TCI #3 is indicated as an active TCI state.

In the example shown in FIG. 6, a UE applies, to reception of the PDSCH, TCI #3 being a TCI state corresponding to CORESET #2.

According to the present embodiment, a PDSCH is possible to be appropriately received even when the PDSCH is a single-TRP PDSCH.

### Variations

For a PDCCH/CORESET in a symbol the same as that of a PDSCH, operation 1 described above may be applied to a case where two TCI states are activated. For a PDCCH/CORESET in a symbol the same as that of a PDSCH, operation 1 described above may be applied to a case where two active TCI states are indicated.

For example, for a PDCCH/CORESET in a symbol the same as that of a PDSCH, a UE may apply operation 1 described above when two TCI states are activated.

In this case, the UE may apply, to reception of the PDSCH, a specific TCI state (for example, first TCI state/second TCI state) out of the two TCI states.

The specific TCI state may be defined in advance in a specification. The specific TCI state may be notified to a UE by using higher layer signaling (RRC/MAC CE).

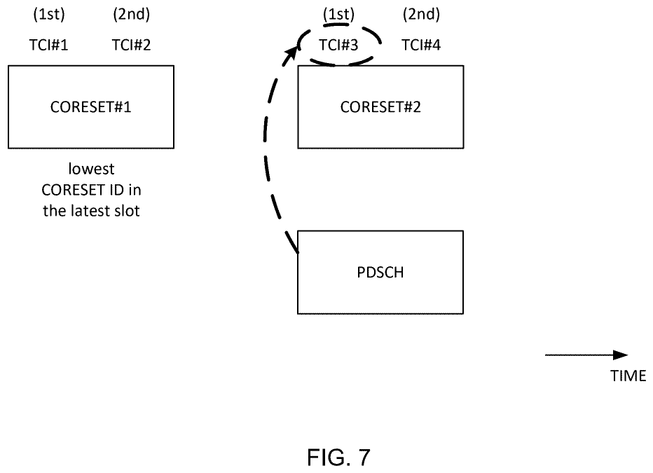

FIG. 7 is a diagram to show an example of application of a TCI state according to an embodiment variation of the present disclosure. In the example shown in FIG. 7, CORESET #1 in the latest slot before reception of a PDSCH is configured and CORESET #2 is configured in at least one symbol the same as that of the PDSCH. For CORESET #1, TCI #1 and TCI #2 are indicated as active TCI states. For CORESET #2, TCI #3 and TCI #4 are indicated as active TCI states.

In the example shown in FIG. 7, a UE applies, to reception of the PDSCH, TCI #3 (or TCI #4) being a TCI state corresponding to CORESET #2. The TCI state to be applied to reception of the PDSCH may be defined in advance in a specification or may be notified to a UE by using higher layer signaling (RRC/MAC CE).

According to the present embodiment variation, a PDSCH is possible to be appropriately received even when the PDSCH is a single-TRP PDSCH.

### Supplements

### Notification of Information to UE

Notification of any information (from a network (NW) (for example, base station (BS))) to a UE in the embodiment described above (in other words, reception of any information by the UE from the BS) may be performed by using physical layer signaling (for example, DCI), higher layer signaling (for example, RRC signaling, MAC CE), a specific signal/channel (for example, PDCCH, PDSCH, reference signal), or a combination of these.

In a case where such notification is made by a MAC CE, the MAC CE may be identified by a fact that a new logical channel ID (LCID) not defined in any existing specifications is included in a MAC sub-header.

In a case where the notification is made by DCI, the notification may be made by a specific field of the DCI, a radio network temporary identifier (RNTI) used for scrambling of cyclic redundancy check (CRC) bits added to the DCI, a format of the DCI, or the like.

Notification of any information to a UE in the above-described embodiment may be made periodically, semi-persistently, or aperiodically.

### Notification of Information from UE

Notification of any information (to an NW) from a UE in the embodiment described above (in other words, transmission/reporting of any information from the UE to a BS) may be performed by using physical layer signaling (for example, UCI), higher layer signaling (for example, RRC signaling, MAC CE), a specific signal/channel (for example, PUCCH, PUSCH, PRACH, reference signal), or a combination of these.

In a case where such notification is made by a MAC CE, the MAC CE may be identified by a fact that a new LCID not defined in any existing specifications is included in a MAC sub-header.

In a case where the notification is made by UCI, the notification may be transmitted by using a PUCCH or PUSCH.

Notification of any information from a UE in the above-described embodiment may be made periodically, semi-persistently, or aperiodically.

### Application of Embodiments

At least one of the above-described embodiments may be applied to a case where a specific condition is met. The specific condition may be defined in a specification or may be notified to a UE/BS by using higher layer signaling/physical layer signaling.

At least one of the above-described embodiments may be applied only to a UE that has reported a specific UE capability or that supports the specific UE capability.

The specific UE capability may indicate at least one of the following:
Support of specific processing/operation/control/information (for example, SFN-CORESET/PDCCH) for at least one of the above-described embodiments

The specific UE capability may be a capability applied over all the frequencies (commonly irrespective of frequency), may be a capability per frequency (for example, any one of cell, band, band combination, BWP, component carrier, or the like, or a combination of these), may be a capability per frequency range (for example, Frequency Range 1 (FR1), FR2, FR3, FR4, FR5, FR2-1, FR2-2), may be a capability per subcarrier spacing (SCS), or may be a capability per Feature Set (FS) or Feature Set Per Component-carrier (FSPC).

The specific UE capability may be a capability applied over all the duplex schemes (commonly irrespective of duplex scheme) or may be a capability per duplex scheme (for example, time division duplex (TDD) or frequency division duplex (FDD)).

At least one of the above-described embodiments may be applied to a case where specific information related to any one of the above-described embodiments (or performing of an operation of any one of the above-described embodiments) is configured/activated/triggered for a UE by higher layer signaling/physical layer signaling. For example, the specific information may be information indicating enabling of an SFN-CORESET/PDCCH, any RRC parameter for a specific release (for example, Rel. 18/19), or the like.

When a UE does not support at least one of the specific UE capabilities or the UE is not configured with the specific information, the UE may apply operations in Rel. 15/16, for example.

### Supplementary Note

Regarding one embodiment of the present disclosure, the following supplementary notes of the invention will be given.

### Supplementary Note 1

A terminal including:
a control section that determines, in a case that configuration information related to a single frequency network (SFN) physical downlink control channel (PDCCH) is configured for a specific scheme and that configuration information related to an SFN physical downlink shared channel (PDSCH) is not configured, when a period from downlink control information scheduling a PDSCH to the PDSCH is shorter than a specific threshold, a Transmission Configuration Indication (TCI) state to be applied to the PDSCH on a basis of a TCI state indicated for a PDCCH configured in a symbol at least the same as a symbol of the PDSCH; and
a receiving section that receives the PDSCH.

### Supplementary Note 2

The terminal according to supplementary note 1, wherein the control section determines, only when the number of TCI states indicated for the PDCCH is one, the TCI state to be applied to the PDSCH on the basis of the TCI state indicated for the PDCCH.

### Supplementary Note 3

The terminal according to supplementary note 1 or 2, wherein the control section applies, when the number of TCI states indicated for the PDCCH is two, a specific TCI state out of two TCI states indicated for the PDCCH to the PDSCH.

### Supplementary Note 4

The terminal according to any one of supplementary notes 1 to 3, wherein the control section determines, when the number of TCI states indicated for the PDCCH is two, the specific TCI state from among the two TCI states indicated for the PDCCH on a basis of higher layer signaling and applies the specific TCI state to the PDSCH.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

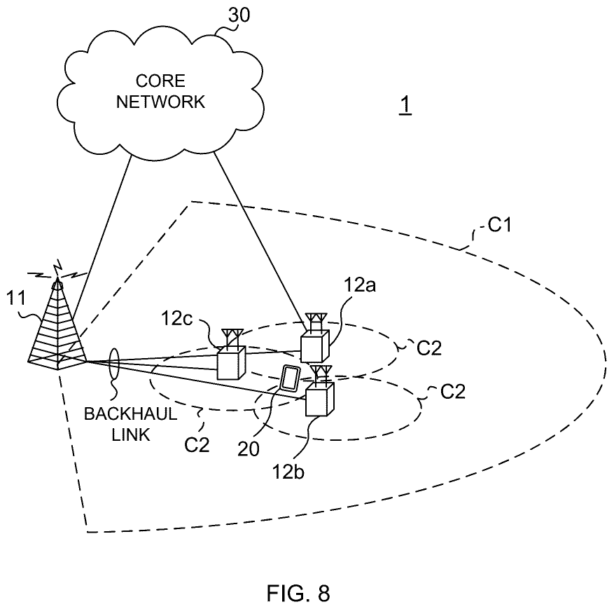

FIG. 8 is a diagram to show an example of a schematic structure of the radio communication system according to one embodiment. The radio communication system 1 (which may be simply referred to as a system 1) may be a system that implements communication by using Long Term Evolution (LTE), 5th generation mobile communication system New Radio (5G NR), or the like the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include, for example, network functions (NFs) such as a User Plane Function (UPF), an Access and Mobility management Function (AMF), a Session Management Function (SMF), a Unified Data Management (UDM), an Application Function (AF), a Data Network (DN), a Location Management Function (LMF), a maintenance operation management (Operation, Administration and Maintenance (Management) (OAM)). Note that one network node may provide a plurality of functions. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

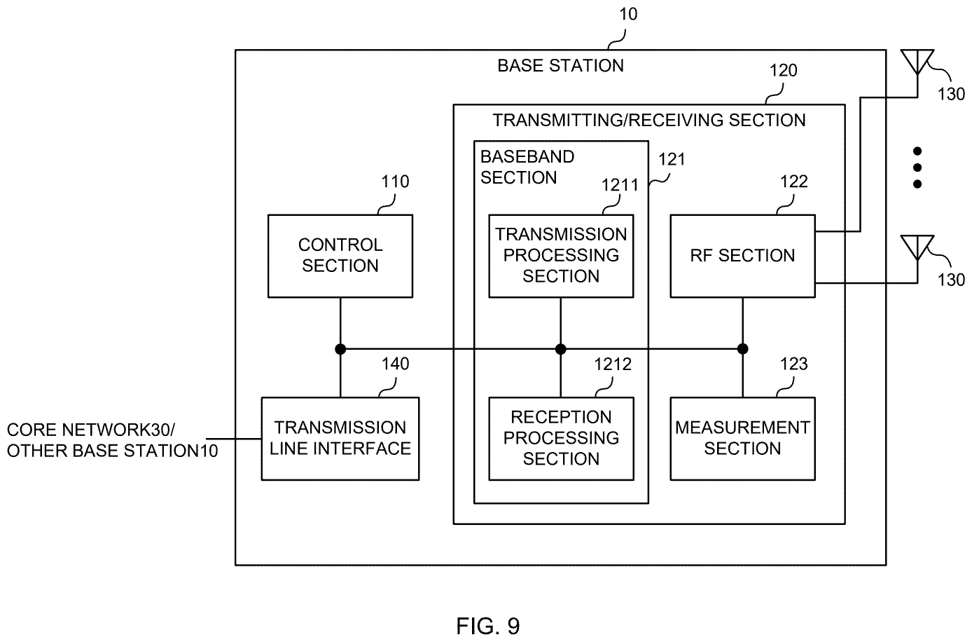

FIG. 9 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception of a signal (backhaul signaling) with an apparatus (for example, a network node that provides an NF) included in the core network 30, another base station 10, or the like for acquisition, transmission, or the like of user data (user plane data), control plane data, or the like for the user terminal 20.

Note that the transmitting section and the receiving section of the base station 10 in the present disclosure may be constituted with at least one of the transmitting/receiving section 120, the transmitting/receiving antennas 130, and the communication path interface 140.

In a case that configuration information related to a single frequency network (SFN) physical downlink control channel (PDCCH) is configured for a specific scheme and that configuration information related to an SFN physical downlink shared channel (PDSCH) is not configured, when a period from downlink control information scheduling a PDSCH to the PDSCH is shorter than a specific threshold, the control section 110 may indicate a Transmission Configuration Indication (TCI) state to be applied to the PDSCH by using a TCI state indicated for a PDCCH configured in a symbol at least the same as that of the PDSCH. The transmitting/receiving section 120 may transmit the PDSCH.

### User Terminal

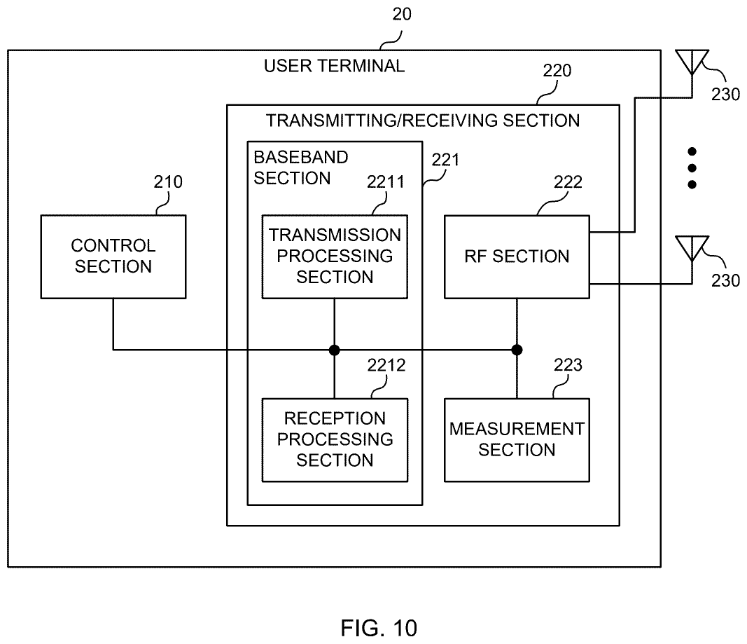

FIG. 10 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

In a case that configuration information related to a single frequency network (SFN) physical downlink control channel (PDCCH) is configured for a specific scheme and that configuration information related to an SFN physical downlink shared channel (PDSCH) is not configured, when a period from downlink control information scheduling a PDSCH to the PDSCH is shorter than a specific threshold, the control section 210 may determine a Transmission Configuration Indication (TCI) state to be applied to the PDSCH on the basis of a TCI state indicated for a PDCCH configured in a symbol at least the same as that of the PDSCH. The transmitting/receiving section 220 may receive the PDSCH.

The control section 210 may determine, only when the number of TCI states indicated for the PDCCH is one, the TCI state to be applied to the PDSCH on the basis of a TCI state indicated for the PDCCH.

The control section 210 may apply, to the PDSCH, when the number of TCI states indicated for the PDCCH is two, a specific TCI state out of two TCI states indicated for the PDCCH.

The control section 210 may determine, when the number of TCI states indicated for the PDCCH is two, the specific TCI state from among two TCI states indicated for the PDCCH on the basis of higher layer signaling and apply the specific TCI state to the PDSCH.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

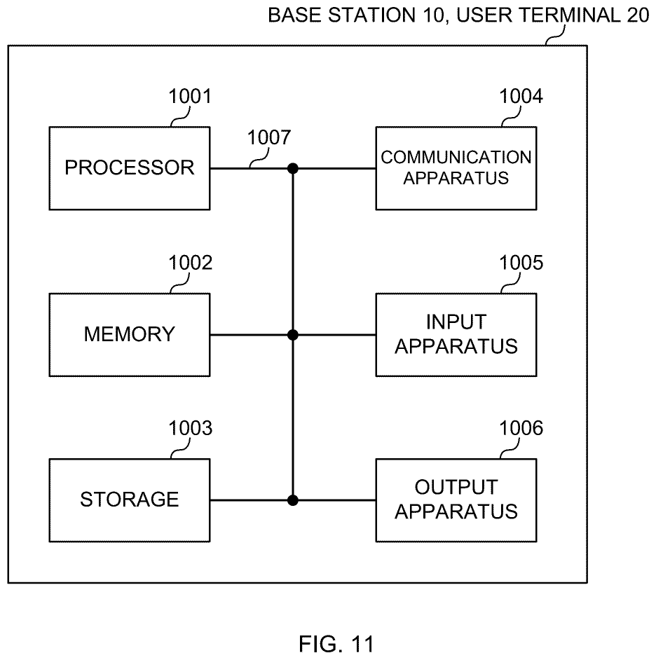

For example, a base station, a user terminal, and so on according to one embodiment of the present disclosure may function as a computer that executes the processes of the radio communication method of the present disclosure. FIG. 11 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### Variations

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CEs).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, an “antenna port group”, a “layer”, “the number of layers”, a “rank”, a “resource”, a “resource set”, a “resource group”, a “beam”, a “beam width”, a “beam angular degree”, an “antenna”, an “antenna element”, a “panel”, and so on may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

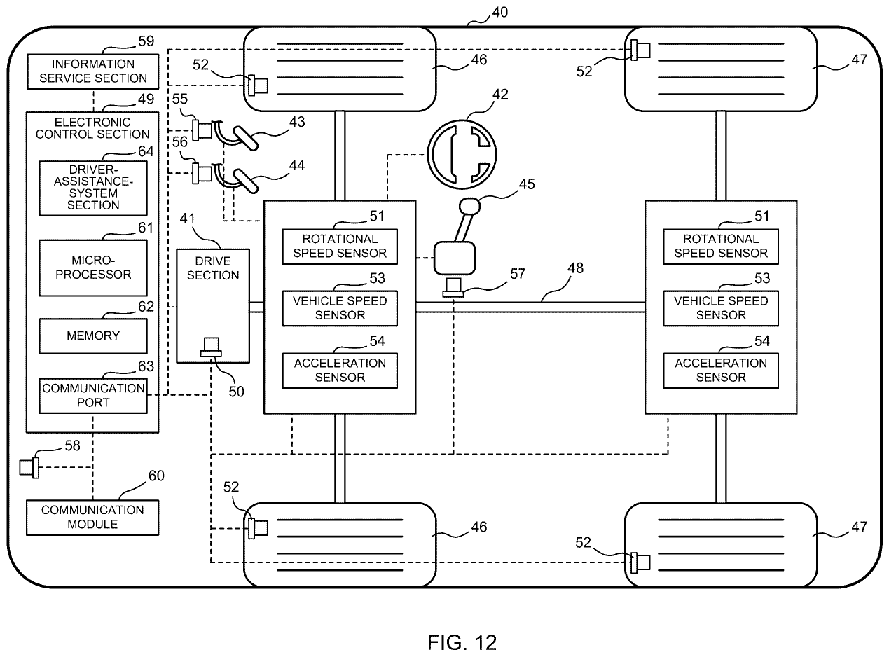

FIG. 12 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions(determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions(determinations)” about receiving (for example, receiving information), transmitting (for example, transmitting information), input, output, accessing (for example, accessing data in a memory), and so on.

In addition, “deciding (determining)” as used herein may be interpreted to mean making “decisions(determinations)” about resolving, selecting, choosing, establishing, comparing, and so on. In other words, “deciding (determining)” may be interpreted to mean making “decisions (determinations)” about some action.

“Decide/deciding (determine/determining)” may be used interchangeably with “assume/assuming”, “expect/expecting”, “consider/considering”, and the like.

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

Now, although the invention according to the present disclosure has been described in detail above, it is apparent to a person skilled in the art that the invention according to the present disclosure is by no means limited to the embodiments described in the present disclosure. Modifications, alternatives, replacements, etc., of the invention according to the present disclosure may be possible without departing from the subject matter and the scope of the present invention defined based on the descriptions of claims. The description of the present disclosure is provided only for the purpose of explaining examples, and should by no means be construed to limit the invention according to the present disclosure in any way.

This application is based on and claims priority to Japanese Patent Application No. 2022-134022, filed on Aug. 25, 2022, the contents of which are incorporated herein by reference in their entirety.

1. A terminal comprising:
a control section that determines, in a case that configuration information related to a single frequency network (SFN) physical downlink control channel (PDCCH) is configured for a specific scheme and that configuration information related to an SFN physical downlink shared channel (PDSCH) is not configured, when a period from downlink control information scheduling a PDSCH to the PDSCH is shorter than a specific threshold, a Transmission Configuration Indication (TCI) state to be applied to the PDSCH on a basis of a TCI state indicated for a PDCCH configured in a symbol at least the same as a symbol of the PDSCH; and
a receiving section that receives the PDSCH.

2. The terminal according to claim 1, wherein
the control section determines, only when the number of TCI states indicated for the PDCCH is one, the TCI state to be applied to the PDSCH on the basis of a TCI state indicated for the PDCCH.

3. The terminal according to claim 1, wherein
the control section applies, when the number of TCI states indicated for the PDCCH is two, a specific TCI state out of two TCI states indicated for the PDCCH to the PDSCH.

4. The terminal according to claim 1, wherein
the control section determines, when the number of TCI states indicated for the PDCCH is two, a specific TCI state from among two TCI states indicated for the PDCCH on a basis of higher layer signaling and applies the specific TCI state to the PDSCH.

5. A radio communication method for a terminal, the radio communication method comprising:
determining, in a case that configuration information related to a single frequency network (SFN) physical downlink control channel (PDCCH) is configured for a specific scheme and that configuration information related to an SFN physical downlink shared channel (PDSCH) is not configured, when a period from downlink control information scheduling a PDSCH to the PDSCH is shorter than a specific threshold, a Transmission Configuration Indication (TCI) state to be applied to the PDSCH on a basis of a TCI state indicated for a PDCCH configured in a symbol at least the same as a symbol of the PDSCH; and
receiving the PDSCH.

6. A base station comprising:
a control section that indicates, in a case that configuration information related to a single frequency network (SFN) physical downlink control channel (PDCCH) is configured for a specific scheme and that configuration information related to an SFN physical downlink shared channel (PDSCH) is not configured, when a period from downlink control information scheduling a PDSCH to the PDSCH is shorter than a specific threshold, a Transmission Configuration Indication (TCI) state to be applied to the PDSCH by using a TCI state indicated for a PDCCH configured in a symbol at least the same as a symbol of the PDSCH; and
a transmitting section that transmits the PDSCH.
